(19) United States
(12) Patent Application Publication
(10) Pub. No.: US 2010/0188298 A1
(43) Pub. Date: Jul. 29, 2010

(54) ANTENNA DEVICE

(75) Inventors: Yuichiro Suzuki, Kanagawa (JP); Hideo Nakanisi, Kanagawa (JP); Masashi Koshi, Ishikawa (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/602,487

(22) PCT Filed: May 31, 2007
(86) PCT No.: PCT/JP2007/061132

§ 371 Date: Nov. 30, 2009

(51) Int. Cl. H01Q 9/04; H01Q 1/24

(52) U.S. Cl. 343/702; 343/700 MS

(57) ABSTRACT

A challenge to be met by the present invention is to provide an antenna device that saves space while using a plate-like inverted F-shaped antenna.

An external memory connector (102) is interposed between a radiating element (1011) and a ground pattern (111). Space of a circuit board (11) can thereby be saved. Further, a feeding section (1014), a first short circuit section (1013), and a second short circuit section (1012) of the plate-like inverted F-shaped antenna element (101) are aligned to each other. A layout minimizing waste thus becomes possible on the occasion of designing of a housing case (12) and the circuit board (11), thereby contributing space saving.

### TECHNICAL FIELD

The present invention relates to an antenna device suitable for use in a portable terminal, such as a portable cellular phone.

### BACKGROUND ART

An antenna called a plate-like inverted F-shaped antenna is used in a potable terminal, such as a portable cellular phone (see; for instance, Patent Document 1). The plate-like inverted F-shaped antenna adopts a structure realized by folding a radiating element made of a plate-like conductor into the shape of an inverted letter F, and has the advantage of being comparatively small and exhibiting a wideband characteristic.

Meanwhile, a portable terminal is recently afforded with an increasing number of chances of handling data, such as storage of image data in a camera, storage of music data downloaded from a site in a network. For this reason, some portable terminals are designed so as to enable attachment of a recording medium, such as card-type flash memory, so as to enable storage of a large volume of data.

Patent Document 1: JP-A-2005-94428

### DISCLOSURE OF THE INVENTION

### Problem that the Invention is to Solve

Although the plate-like inverted F-shaped antenna can be miniaturized, the antenna occupies a large volume because of its shape; hence, the antenna makes up a large proportion of a circuit board of a portable terminal, which impedes the pursuit of miniaturization of the portable terminal.

The present invention has been conceived in the circumstance and aims at providing an antenna device that makes it possible to save space while using a plate-like inverted F-shaped antenna.

### Means for Solving the Problem

An antenna device of the present invention has a radiating element; a ground pattern; a feeding section for feeding power to the radiating element; a first short circuit section that connects the radiating element to the ground pattern; and an external memory connector interposed between the radiating element and the ground pattern.

By means of the configuration, the external memory connector is interposed between the radiating element of the plate-like inverted F-shaped antenna element and the ground pattern. Hence, space of the circuit board can be saved. As a result, when the antenna device of the present invention is applied to a portable terminal, such as a portable cellular phone, the portable terminal can be miniaturized.

In the configuration, the external memory connector has a conductive chassis, and the conductive chassis is connected to the ground pattern.

By means of the configuration, since the conductive chassis of the external memory connector is connected to the ground pattern, degradation of an antenna gain, which would otherwise be caused by insertion of memory into the external memory connector, can be prevented.

In the configuration, the antenna device has the second short circuit section that connects the radiating element to the ground pattern.

By means of the configuration, the antenna device has the plurality of short circuit sections. The frequency band of the plate-like inverted F-shaped antenna element can be changed by connecting at least one of the short circuit sections to the ground pattern.

In the configuration, at least one of the first short circuit section and the second short circuit section is provided with a switch for establishing a connection to the ground pattern.

By means of the configuration, the short circuit section is connected to or disconnected from the ground pattern by the switch, whereby the frequency band of the antenna device can be changed. The plate-like inverted F-shaped antenna element is thereby designed in conformance with specifications of a portable cellular phone, so that the antenna device can be made compatible with both the domestic frequency band in Japan and an oversea frequency band. For instance, a domestic frequency band of the portable cellular phone in Japan ranges 1.9 GHz to 2.1 GHz, and an oversea frequency band ranges from 880 MHz to 960 MHz or 1.7 GHz to 1.9 GHz.

In the configuration, the plurality of short circuit sections and the feeding section are aligned to each other.

By means of the configuration, since the feeding section and the short circuit sections are aligned to each other, and hence space saving can be achieved.

A portable terminal of the present invention has the antenna device.

By means of the configuration, space saving is accomplished, and a portable terminal is miniaturized.

A portable terminal of the present invention has the antenna device; a circuit board; a housing case; and a fastening section that fastens the circuit board to the housing case, wherein at least one of the plurality of short circuit sections or the feeding section is jointly fastened to the circuit board by means of the fastening section.

By means of the configuration, since the antenna device and the circuit board can be jointly fastened to the housing case with a screw, the screw used for fastening the circuit board to the housing case can be caused to act also as a screw for fastening the antenna device to the circuit board, so that cost cutting is accomplished.

### Advantage of the Invention

An antenna device of the present invention has an external memory connector interposed in a space between a radiating element and a ground pattern. Further, a feeding section and short circuit sections are aligned to each other; hence, space saving is accomplished while a plate-like inverted F-shaped antenna element is used, so that a portable terminal can be miniaturized.

### BRIEF DESCRIPTION OF THE DRAWINGS

FIG. 1 is a perspective view showing a general structure of a surrounding area including an antenna device of a portable terminal of a first embodiment of the present invention.

FIG. 2 is a perspective view acquired when the surrounding area including the antenna device shown in FIG. 1 is viewed in an opposite direction.

FIG. 3 is an enlarged perspective view of the surrounding area including the antenna device shown in FIG. 2.

FIG. 4 is a perspective view showing a general structure of a surrounding area including an antenna device of a portable terminal of a second embodiment of the present invention.

FIG. 5 is a perspective view showing a general structure of a surrounding area including an example application of the antenna device of the portable terminal of the second embodiment of the present invention.

### DESCRIPTIONS OF THE REFERENCE NUMERALS AND SYMBOLS

1, 2 PORTABLE TERMINAL
10 ANTENNA DEVICE
11 CIRCUIT BOARD
12 HOUSING CASE
13 SCREW
14 SWITCH
20 FLASH MEMORY
101 PLATE-LIKE INVERTED F-SHAPED ANTENNA ELEMENT
102 EXTERNAL MEMORY CONNECTOR
111 GROUND PATTERN
112 FEEDER PATTERN
1011 RADIATING ELEMENT SECTION
1012, 1013 SHORT CIRCUIT SECTION
1014 FEEDING SECTION
1015 TAPPED HOLE

### BEST MODES FOR IMPLEMENTING THE INVENTION

Embodiments suitable for implementing the present invention are hereunder described in detail by reference to the drawings.

### First Embodiment

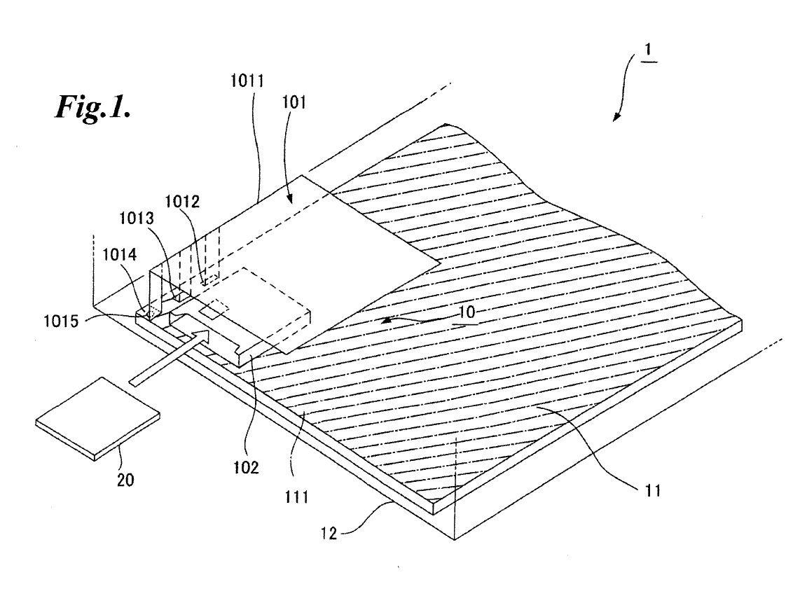

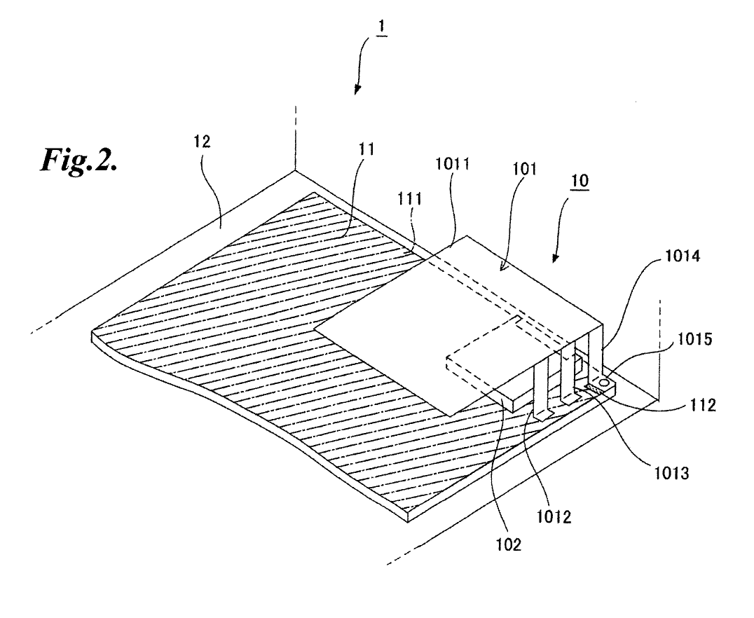

FIG. 1 is a perspective view showing a general configuration of a surrounding area including an antenna device of a portable terminal of a first embodiment of the present invention. FIG. 2 is a perspective view acquired when the surrounding area including the antenna device shown in FIG. 1 is viewed in an opposite direction. In FIGS. 1 and 2, a portable terminal 1 of the present embodiment is made up of an antenna device 10, a circuit board 11, and a housing case 12. The antenna device 10 has a plate-like inverted F-shaped antenna element 101 and an external memory connector 102 disposed immediately below the plate-like inverted F-shaped antenna element 101.

The plate-like inverted F-shaped antenna element 101 is made up of a radiating element section 1011 that acts as a main body and that is made of a plate-shaped conductor; a feeding section 1014; short circuit sections 1013 and 1012; and a ground pattern 111. The ground pattern 111 is laid on the circuit board 11. The circuit board 11 is a board built from a multilayered structure. Interconnection lines or chip components are mounted on each of the layers, and the ground pattern 111 is laid over the entirety of any one or some of the layers. Throughout the drawings, the ground pattern 111 is designated by a dashed line.

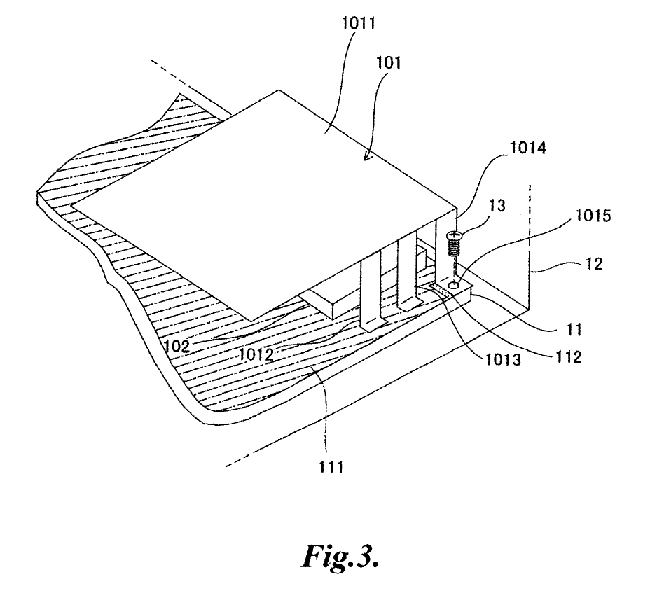

Each of the feeding section 1014 and the short circuit sections 1013 and 1012 is made up of an essentially-L-shaped conductor plate, and these sections are aligned along one of four sides of the radiating element section 1011. A tapped hole 1015 used for fastening the circuit board 11 to the housing case 12 is made in an area where the feeding section 1014 contacts the circuit board 11. The plate-like inverted F-shaped antenna element 101 is jointly fastened to the circuit board 11 and the housing case 12 by means of the tapped hole 1015. FIG. 3 is an enlarged perspective view of the antenna shown in FIG. 2. As illustrated, a screw 13 is screw-engaged into the tapped hole 1015, whereby the plate-like inverted F-shaped antenna element 101 is jointly fastened to the circuit board 11 and the housing case 12. The tapped hole 1015 is not limitedly made in the feeding section 1014 but may also be made in the short circuit sections 1012 and 1013.

The feeding section 1014 is connected to a feeding pattern (a feeder pattern) 112 of a radio circuit implemented on the circuit board 11, and the short circuit sections 1013 and 1012 are connected to the ground pattern 111.

In the plate-like inverted F-shaped antenna element 101, the feeding section 1014 and the short circuit sections 1013 and 1012 are aligned to each other, whereby a layout that minimizes waste can be realized on the occasion of designing of the housing case 12 and the circuit board 11, to thus save space. Further, making the tapped hole 1015 in the feeding section 1014 enables the screw 13 used for fastening the circuit board 11 to the housing case 12 to act also as a screw for fastening the plate-like inverted F-shaped antenna element 101 to the circuit board 11, so that cost cutting can be attained. The tapped hole 1015 is not necessarily made in the feeding section 1014 and may also be made in the short circuit section 1013 or 1012.

The external memory connector 102 is for connecting card-type data storage flash memory (e.g., an SD card and a micro SD card) 20 to the portable terminal 1. The external memory connector 102 is interposed between the radiating element 1011 of the plate-like inverted F-shaped antenna element 101 and the ground pattern 111. Space exists between the radiating element 1011 and the ground pattern 111. The external memory connector 102 is positioned by utilization of the space, thereby saving the space of the circuit board 11. In particular, the external memory connector 102 acting as a component makes up a larger proportion of the circuit board 11 than do other components; hence, utilization of the space leads to a great progress in space saving.

The external memory connector 102 has a conductive chassis (e.g., a metal chassis), and the conductive chassis is grounded to the ground pattern 111 of the circuit board 11. When the external memory connector 102 is provided in the vicinity of the plate-like inverted F-shaped antenna element 101, a radiation gain of the antenna is reduced at the time of insertion of the flash memory 20, because the flash memory usually exhibits a metallic property. Since the state of expansion and contraction of a spring making up the external memory connector 102 is changed as a result of insertion and removal of the flash memory, the radiation gain of the antenna is decreased.

Accordingly, the conductive chassis of the external memory connector 102 is grounded, whereby degradation of the antenna gain, which would otherwise be caused by inserting the flash memory 20 into the external memory connector 102, can be prevented.

As mentioned above, in the portable terminal 1 of the present embodiment, the external memory connector 102 is positioned between the radiating element section 1011 and the ground pattern 111, so that the space of the circuit board 11 can be saved. A component for implementing a new function can also be added to an excess space without miniaturization of the circuit board 11.

Since the feeding section 1014 of the plate-like inverted F-shaped antenna element 101 and the short circuit sections 1013 and 1012 are aligned to each other, a layout that minimizes waste can be realized on the occasion of designing of the housing case 12 and the circuit board 11, so that space saving can be accomplished.

The tapped hole 1015 for fastening the circuit board 11 to the housing case 12 is made in an area of the feeding section 1014 that contacts the circuit board 11. Further, the plate-like inverted F-shaped antenna element 101 and the circuit board 11 can be jointly fastened to the housing case 12 by means of the screw 13. Hence, the screw for fastening the circuit board 11 to the housing case 12 can be caused to act also as a screw for fastening the plate-like inverted F-shaped antenna element 101 to the circuit board 11, whereby cost cutting is accomplished.

Since the conductive chassis of the external memory connector 102 is grounded to the ground pattern 111 of the circuit board 11, degradation of an antenna gain, which would otherwise be caused by insertion of the flash memory 20 into the external memory connector 102, can be prevented.

Although the present embodiment illustrates the example including two short circuit sections 1012 and 1013, the number of short circuit sections is not limited to two, but one short circuit section may also suffice.

Although the present embodiment illustrates the example in which each of the feeding section 1014 and the short circuit sections 1013 and 1012 is made of a substantially-L-shaped conductor plate, the essential requirement for these sections is that they should be connected to the ground pattern. The feeding section and the short circuit sections can also be; for instance, linear conductor plates or conductor wires.

### Second Embodiment

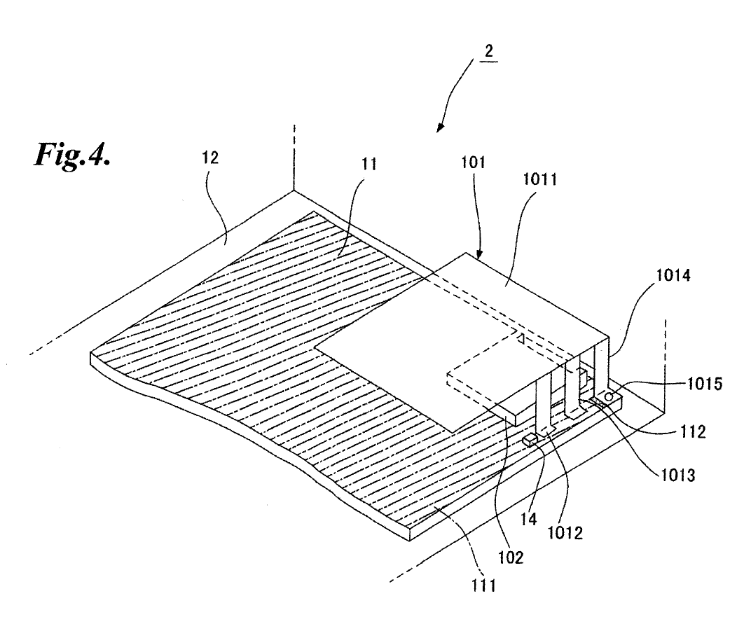

FIG. 4 is a perspective view showing a general configuration of a surrounding area including an antenna device of a portable terminal of a second embodiment of the present invention. Elements common between FIG. 4 and FIG. 1 or 2 are assigned the same reference numerals. A portable terminal 2 of the present embodiment differs from its counterpart of the first embodiment in that the terminal 2 has a switch 14 for switching a frequency band of the plate-like inverted F-shaped antenna element 101. The switch 14 is provided on the circuit board 11. The short circuit section 1012 of the plate-like inverted F-shaped antenna element 101 and the switch 14 are connected together by means of an interconnection line laid on the circuit board 11, and the switch 14 and the ground pattern 111 are also connected by means of the interconnection line on the circuit board 11. The short circuit section 1012 is connected to the ground pattern 111 of the circuit board 11 as a result of activation of the switch 14. In contrast, the short circuit section 1012 is disconnected as a result of deactivation of the switch 14. A switch capable of being turned on or off electrically or by means of a high frequency is principally used for the switch 14.

In the case of a portable cellular phone, an available frequency band is; for instance, 1.9 GHz to 2.1 GHz in Japan and 880 MHz to 960 MHz or 1.7 GHz to 1.9 GHz outside Japan. When the plate-like inverted F-shaped antenna element 101 is designed in conformance with specifications of a portable cellular phone, the switch 14 is turned on, to thus connect the short circuit section 1012 to the ground pattern 111 of the circuit board 11, thereby performing switching to a domestic frequency band in Japan ranging from 1.9 GHz to 2.1 GHz. The switch 14 is turned off, to thus disconnect the short circuit section 1012 from the ground pattern 111 of the circuit board 11, thereby performing switching to an oversea frequency band ranging from 880 MHz to 960 MHz or 1.7 GHz to 1.9 GHz. The previously-mentioned frequency bands are mere examples, and an 800 MHz band can also be employed in Japan.

Use of the switch also makes it possible to make the antenna device compatible with a different radio frequency band, such as a 1.5-GHz band for a GPS and a 2.4-GHz band for Bluetooth.

As mentioned above, in the portable terminal 2 of the present embodiment, the short circuit section 1012 of the plate-like inverted F-shaped antenna element 101 is provided with the switch 14 for grounding the short circuit section 1012 to the ground pattern 111, thereby enabling switching of the frequency band of the plate-like inverted F-shaped antenna element 101. Accordingly, the plate-like inverted F-shaped antenna element 101 is designed in conformance with specifications of a portable cellular phone, whereby the antenna device can be made compatible with both the domestic frequency band in Japan and an oversea frequency band. Further, the antenna device can also be made compatible with application of a different frequency band, such as a GPS and Bluetooth.

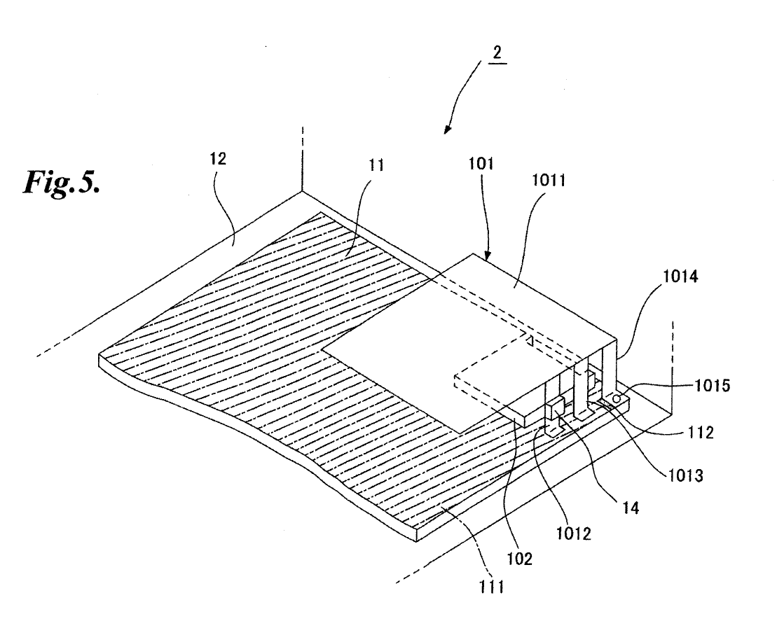

In the embodiment, the switch 14 is provided on the circuit board 11. However, the switch is not limited to a location on the circuit board 11. As shown in FIG. 5, the switch may also be provided in the short circuit section 1012. Moreover, the switch may also be provided in the short circuit section 1013.

In the first and second embodiments, the two short circuit sections 1013 and 1012 are provided. However, the number of short circuit sections is not limited, and three or more short circuit sections can also be provided. The number of compatible frequency bands can thereby be increased.

Although the present invention has been described in detail and by reference to the specific embodiments, it is manifest to those skilled in the art that the present invention is susceptible to various alterations or modifications without departing the spirit and scope of the present invention.

### INDUSTRIAL APPLICABILITY

The present invention yields an advantage of saving a space while using a plate-like inverted F-shaped antenna and can be applied to general portable terminals that perform radio communication, such as portable cellular phones.

1. An antenna device comprising:
a radiating element;
a ground pattern;
a feeding section for feeding power to the radiating element;
a first short circuit section that connects the radiating element to the ground pattern; and
an external memory connector interposed between the radiating element and the ground pattern.

2. The antenna device according to claim 1, wherein the external memory connector has a conductive chassis, and the conductive chassis is connected to the ground pattern.

3. The antenna device according to claim 1, further comprising a second short circuit section that connects the radiating element to the ground pattern.

4. The antenna device according to claim 3, wherein at least one of the first short circuit section and the second short circuit section is provided with a switch for establishing a connection to the ground pattern.

5. The antenna device according to claim 3, wherein the plurality of short circuit sections and the feeding section are aligned to each other.

6. A portable terminal having the antenna device defined in claim 1.

7. A portable terminal comprising the antenna device defined in claim 3; a circuit board; a housing case; and a fastening section that fastens the circuit board to the housing case, wherein at least one of the plurality of short circuit sections or the feeding section is jointly fastened to the circuit board by means of the fastening section.
